(19) United States
(12) Patent Application Publication
(10) Pub. No.: US 2010/0205757 A1
(43) Pub. Date: Aug. 19, 2010

(54) BYPASS PIG

(76) Inventor: Bruce A. Munden, Galveston, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/388,138

(22) Filed: Feb. 18, 2009

(51) Int. Cl. B08B 9/04

(52) U.S. Cl. 15/104.061

(57) ABSTRACT

Embodiments of the present invention generally relate to a bypass pig. In one embodiment, a pig for cleaning a tubular string includes a cylindrical body and two or more scrapers disposed along an outer surface of the body. The scrapers are operable to engage and clean an inner surface of the tubular string. The pig further includes a bypass formed between the scrapers. The bypass is operable to: intake a portion of propellant from a tail of the body, conduct the portion of propellant along an outer surface of the body, and discharge the portion of propellant in front of the body.

### BACKGROUND OF THE INVENTION

1. Field of the Invention

Embodiments of the present invention generally relate to a bypass pig.

2. Description of the Related Art

Pipeline pigs are propelled by fluid pressure through the interior of pipelines to clean wax, sludge, scale, debris, and other materials from the inner surfaces of the pipeline. Pipeline pigs may also be used to fill a pipeline with water for hydrotesting and remove the water once testing is finished. Pipeline pigs may also be used to verify tolerances of the pipeline and inspect for corrosion. Pipeline pigs may also be used to remove accumulated liquids or solids in pipelines. Pipeline pigs may also be used to separate different types of fluids which may be traveling through the same pipeline.

Two common types of pipeline pigs are foam pigs and mandrel pigs. Conventional foam type pipeline pigs usually have a generally cylindrical body formed of polyurethane foam. The foam type pipeline pigs are much lighter in weight and are more flexible than mandrel pigs. However, foam type pigs are usually disposable since they cannot be redressed. Conventional mandrel pigs usually have two or more resilient cups mounted on an elongate rigid central shaft or on a hollow, generally cylindrical rigid body. The cups have a peripheral lip which extends radially to engage the interior of the pipeline and transmits a radial component of the propelling fluid pressure to the inner walls of pipeline to affect a tighter fit. Some mandrel pigs may also be provided with wire brush members on their periphery for scraping the inner wall of the pipeline.

### SUMMARY OF THE INVENTION

Embodiments of the present invention generally relate to a bypass pig. In one embodiment, a pig for cleaning a tubular string includes a cylindrical body and two or more scrapers disposed along an outer surface of the body. The scrapers are operable to engage and clean an inner surface of the tubular string. The pig further includes a bypass formed between the scrapers. The bypass is operable to: intake a portion of propellant from a tail of the body, conduct the portion of propellant along an outer surface of the body, and discharge the portion of propellant in front of the body.

In another embodiment, a pig for cleaning a tubular string includes a cylindrical body and a scraper wound around and along an outer surface of the body. The scraper is operable to engage and clean an inner surface of the tubular string. The pig further includes a bypass formed between windings of the scraper. The bypass is operable to intake a portion of propellant from a tail of the body, conduct the portion of propellant along and around an outer surface of the body, and discharge the portion of propellant in front of the body.

In another embodiment, a method of cleaning a tubular string includes injecting propellant behind a pig, thereby propelling the pig through the tubular string; and bypassing a portion of the propellant along an outer portion to a front of the pig, thereby creating a jet in front of the pig.

In another embodiment, a pig for cleaning a tubular string includes a mandrel and a seal. The seal is coupled to the mandrel, operable to engage an inner surface of the tubular string, and has a bypass formed longitudinally therethrough. The pig further includes a scraper disposed along the mandrel. The scraper is operable to engage and clean an inner surface of the tubular string.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a longitudinal cross-section of a bypass pig, according to one embodiment of the present invention. FIG. 1B is a radial cross-section of the bypass pig.

FIG. 2 illustrates a use of the bypass pig, according to another embodiment of the present invention.

FIG. 3A is a longitudinal cross-section of a bypass pig, according to another embodiment of the present invention. FIG. 3B is an end view of the bypass pig.

### DETAILED DESCRIPTION

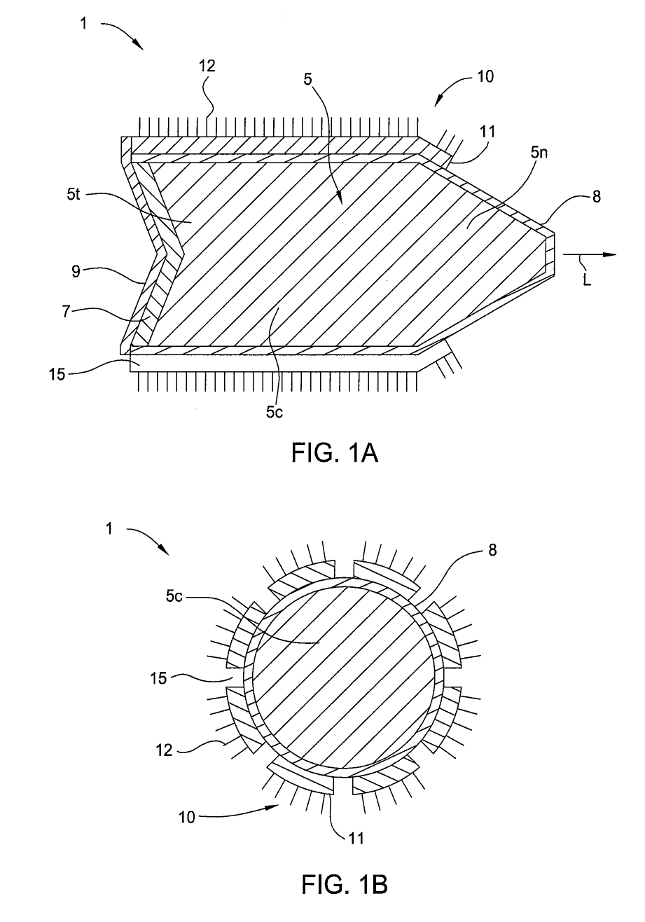

FIG. 1A is a longitudinal cross-section of a bypass pig 1, according to one embodiment of the present invention. FIG. 1B is a radial cross-section of the bypass pig. The pig 1 may include a body 5, a tail plate 7, one or more scrapers 10, and a bypass 15. A longitudinal axis L is shown for reference. The body 5 may be made from a flexible material, such as a polymer. The polymer may be foamed polymer, such as polyurethane, or a non-foamed polymer. The body 5 may be bullet-shaped and include a nose portion 5n, a tail portion 5t and a cylindrical portion 5c. The tail portion 5t may be concave or flat. The nose portion 5n may be conical, hemispherical or hemi-ellipsoidal. Alternatively, the nose portion 5n may instead be a second tail portion so that the pig is bidirectional. The tail plate 7 may be bonded to the tail portion 5n during molding of the body 5. The shape of the tail plate 7 may correspond to the tail portion 5t. The tail plate 7 may be made from a (non-foamed) polymer, such as polyurethane.

The scrapers may be brushes 10 and may each extend along an outer surface of the body 5. Each brush 10 may include a base 11 and bristles 12 embedded therein along a length and a width thereof. The bristles 12 may be made from a metal or alloy, such as steel, or a polymer. Alternatively, grains of abrasive material, such as sand, glass, diamond dust, or carbide (i.e., silicon or tungsten) may be embedded in the base 11 instead of the bristles 12. Each base 11 may be a strip made from a (non-foamed) polymer, such as polyurethane, ploychloroprene, or polyisoprene. Each base 11 may be a cylindrical segment to conform to the outer surface of the cylindrical portion 5c. Each base 11 may be longitudinally straight. Alternatively, each base 11 may extend longitudinally and tangentially along the body 5 in a helical orientation or a single base 11 may be helically wound along the body 5, thereby rotating the pig as the pig travels longitudinally through a tubular string. This spiral motion may serve to more evenly distribute wear to the brushes 10.

Each brush 10 may extend from the tail plate 7 or portion 5t, along the cylindrical portion 5c, and over a portion of the nose 5n. Each brush 10 may be bonded to the body by an adhesive 8, such as a (non-foamed) polymer, such as polyurethane, ploychloroprene, or polyisoprene. The adhesive 8 may be applied around the cylindrical portion 5c, over the nose 5n, and an outer surface of the tail plate 5t so that the adhesive serves as an overcoat 8 for the body 5 as well as an adhesive for the brushes 10. A tail coat 9 may be applied to the rear surface of the tail plate 7 and the bases 11. The tail coat 9 may be a (non-foamed) polymer, such as polyurethane, ploychloroprene, or polyisoprene. The brushes 10 may be tangentially spaced around the body 5, thereby defining a bypass 15 between each brush 10. The bypasses 15 may each be channels extending along a length of the brushes 10. Relative to the bypasses 15, the brushes 10 may substantially occupy the outer surface of the cylindrical portion 5c, such as more than half, at least two-thirds, at least three-quarters, or at least nine-tenths of the outer surface.

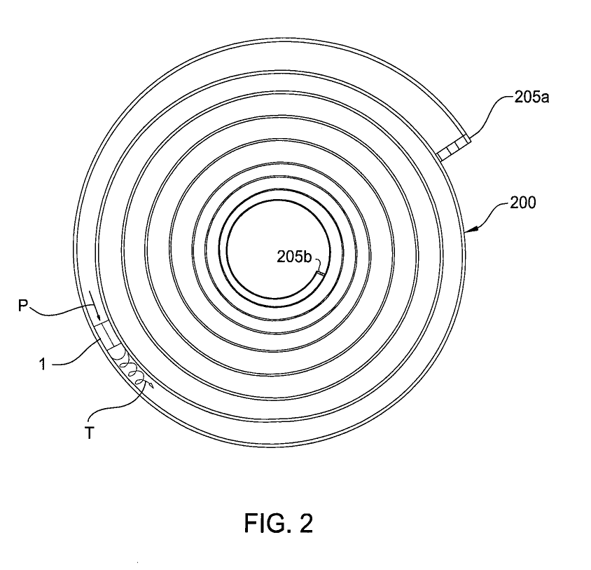

FIG. 2 illustrates a use of the bypass pig 1, according to another embodiment of the present invention. The pig 1 may be deployed in a tubular string, such as coiled tubing 200, reeled pipe, or a pipeline. In preparing the coiled tubing 200 for deployment of the pig 1, an inlet 205a and outlet 205b of the tubing 200 may be located at or near ground level to allow for easier access. The inlet 205a and outlet 205b are arbitrary and may be reversed.

A clamp (not shown) may be secured to each of the inlet 205a and outlet 205b. Each clamp may have a flange to receive corresponding flanges of a pig launcher (not shown) and a pig receiver (not shown). A suitable pig launcher and receiver are illustrated in FIG. 1 of U.S. Pat. No. 5,230,842, which is herein incorporated by reference in its entirety. Each of the launcher and receiver may include a header pipe and a chamber pipe. The header pipe may include ports for venting, draining, measuring pressure, and/or injecting cleaning fluid. The chamber may include a propellant port, one or more pressure gage ports, and a door at an end thereof for insertion or removal of the pig. The chamber pipe may have an increased diameter relative to the header pipe and each of the launcher and receiver may further include a reducer connecting the two pipes. The inner diameter of the header pipe may correspond to the inner diameter of the coiled tubing and the inner diameter of the chamber pipe may be greater than the outer diameter of the bristles 12 to facilitate ease of insertion or removal of the pig 1.

The outer diameter of the cylindrical portion 5c may be equal to, slightly greater than, or slightly less than the inner diameter of the coiled tubing 200. Having interference between the pig 1 and the coiled tubing 200 may ensure tight engagement of the bristles 12 with the inner surface of the coiled tubing 200. Alternatively, the pig may be deployed into the coiled tubing 200 without using a launcher.

Once the launcher and receiver have been connected to the respective inlet 205a and outlet 205b, the pig 1 may be inserted into the launcher and a propellant P, may be injected into the launcher chamber behind the pig 1. The propellant P may be a fluid, such as a liquid or compressed gas, such as ambient air, dry air, or nitrogen. The pig 1 may be launched into the coiled tubing 200. As the pig 1 travels through the coiled tubing 200, the bristles 12 may drag along an inner surface of the coiled tubing 200, thereby dislodging debris from the inner surface. A portion of the propellant P may bypass the pig 1 via the bypasses 15. As the bypassed portion of the propellant P exits the bypasses 15, a fluid jet T may be created proximately in front of the pig 1, thereby facilitating removal of debris from the inner surface of the coiled tubing 200. A velocity of the fluid jet T may be sufficient to disrupt the boundary layer, thereby churning the debris and the fluid jet T. The fluid jet T may also clean debris from the bristles 12. Locating the bypass along an outer portion of the pig 1 advantageously maintains increased (i.e., maximum) local velocity of the jet T at an inner surface of the coiled tubing 200 where the cleaning is occurring.

The pig 1 may continue through the coiled tubing 200 until the pig 1 is caught by the receiver connected to the outlet 205b. The pig 1 may then be removed and re-inserted into the launcher and the trip repeated. Alternatively, if the pig is bi-directional, the pig may be sent back-through the coiled tubing 200 to the inlet 205a. The cycle may be repeated until a white-metal or near white-metal finish, such as NACE number one or two, is achieved.

The coiled tubing 200 may be new or used. If new, the pig may be used to clean manufacturing debris. Coiled tubing 200 is typically made from plate rolled and longitudinally welded together. Manufacturing debris, such as weld flash or flux may be left inside the coiled tubing 200. If the coiled tubing has returned from a wellbore, a film of drilling fluid, such as mud, and associated debris, such as sand or clay, may be left inside the coiled tubing 200.

If the pig 1 should encounter a major obstruction, the propellant pressure may be increased to either force the pig 1 past the obstruction or burst the pig, thereby loosening the obstruction.

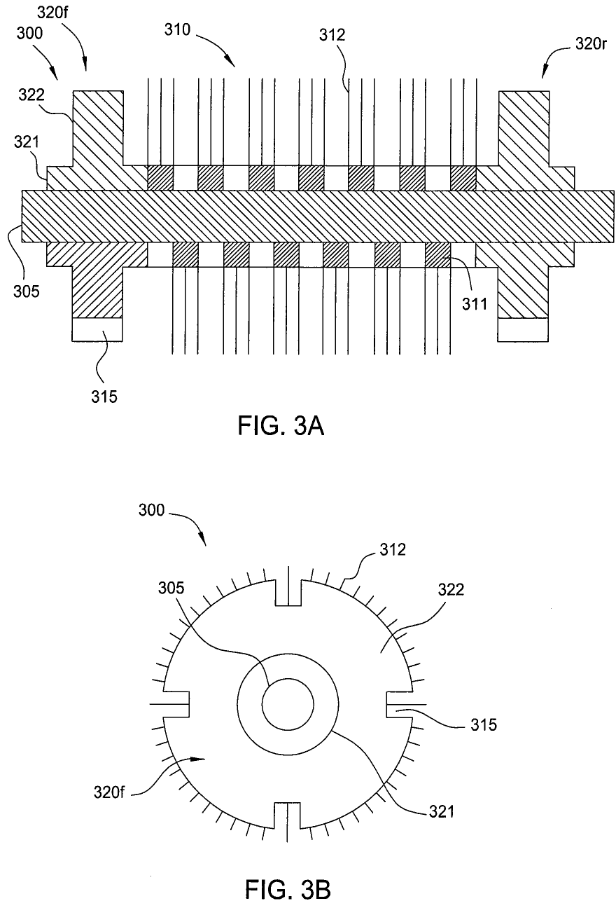

Once the coiled tubing 200 has been sufficiently cleaned, an inner surface thereof may be coated. The coating (not shown) may be applied by injecting liquid coating material, such as a polymer (i.e., epoxy, polyurethane, or polytetrafluoroethylene) between two extruder pigs (not shown) of a pigtrain and propelling the pigtrain using dry air or nitrogen through the coiled tubing 200. Suitable pipeline extruder pigs are illustrated in FIGS. 3-6 of the '842 patent. The pipeline extruder pigs may be modified for use in coiled tubing or reeled pipe by omitting the intermediate disc members 120 and 122 and shortening the base portion of 118 of the leading pig 112 and omitting the intermediate disc members 120a and 122a and shortening the base portion of 118a of the trailing pig 114. As the extruder pigs progress through the tubing 50, they may apply a uniform thickness coating of the material onto the interior surface of the tubing 50. After a layer of coating material has been applied, the coiled tubing 200 may be subjected to a drying or curing process to insure the coating bonds to the tubing 200. For instance, dry air may be passed through the tubing to dry the coating or the tubing may be subjected to heat to cure the lining material thereby creating a mechanical bond between the coating and the tubing 50. Additional layers may be applied. Each layer may have a thickness of less than 0.0015 inch and, if multi-layer, the aggregate thickness of the coating may be less than 0.004 inch.

FIG. 3A is a longitudinal cross-section of a bypass pig 300, according to another embodiment of the present invention. FIG. 3B is an end view of the bypass pig 300. The pig 300 may include a mandrel 305, a front seal 320f, a rear seal 320r, a scraper 310, and a bypass 315. The mandrel 305 may be a rod having a threaded outer surface and made from a metal or alloy, such as steel. Alternatively, the mandrel 305 may be a threaded tubular capped at each longitudinal end thereof.

The scraper 310 may be a brush extending along an outer surface of the mandrel 305. The brush 310 may include a base 311 and bristles 312 bonded thereto along a length and width thereof. The base 311 may be a helically wound strip or channel made from a metal or alloy, such as steel. An inner surface of the base 311 may be threaded corresponding to the threaded outer surface of the mandrel 305. The bristles 12 may be made from a metal or alloy, such as steel, or a polymer.

The seals 320f, r may each include a hub portion 321, a disc portion 322, and one or more bypasses 315. The front and rear designations may be arbitrary as the pig 300 may be bidirectional. The seals 320f, r may each be made from a polymer, such as polyurethane, ploychloroprene, or polyisoprene. An inner surface of the hub portion 321 may be threaded corresponding to the threaded outer surface of the mandrel 305. An inner end of each hub portion 321 may abut a respective end of the base 311, thereby retaining the brush 310 on the mandrel 305. The bypasses 315 may each be a channel formed in an outer surface of each of the disc portions 322 and extending longitudinally therethrough. Alternatively, the bypasses may each be a hole formed longitudinally through each of the disc portions 322. The bypasses 315 may be tangentially spaced around each of the disc portions 322. Alternatively, each hub 321 may be a separate member made from a metal or alloy, such as steel, and bonded to the disc 322. Alternatively, nuts may be used to straddle the disc portion 322 and the base 311 instead of the hub 321. Alternatively, cups may be used instead of the discs 322. Alternatively, the bypasses 315 of the front seal 320f may be misaligned with the bypasses 315 of the rear seal 320r.

An outer diameter of each disc portion 322 may be equal to or slightly greater than an inner diameter of the coiled tubing 200 to ensure tight sealing engagement of the discs 322 with the coiled tubing 200. The bristles 312 may radially extend from the base 311 to, or slightly outward past the outer diameter of the disc portions 322 to ensure tight engagement of the bristles 312 with the coiled tubing 200.

In operation, the pig 300 may be deployed in the coiled tubing 200 using the launcher and receiver, discussed above. The pig 300 may be deployed instead of the pig 1 or as a subsequent cleaning step to deployment of the pig 1. As the pig 300 travels through the coiled tubing 200, the bristles 312 may drag along an inner surface of the coiled tubing 200, thereby dislodging debris from the inner surface. A portion of the propellant P may bypass the pig 300 via the bypasses 315 (and leak through the brushes). As the bypassed portion of the propellant P exits the bypasses 15, the fluid jet T may be created proximately in front of the pig 1, thereby facilitating removal of debris from the inner surface of the coiled tubing 200.

While the foregoing is directed to embodiments of the present invention, other and further embodiments of the invention may be devised without departing from the basic scope thereof, and the scope thereof is determined by the claims that follow.

1. A pig for cleaning a tubular string, comprising:
a cylindrical body;
two or more scrapers disposed along an outer surface of the body, the scrapers operable to engage and clean an inner surface of the tubular string; and
a bypass formed between the scrapers, the bypass operable to:
intake a portion of propellant from a tail of the body,
conduct the portion of propellant along an outer surface of the body, and
discharge the portion of propellant in front of the body.

2. The pig of claim 1, further comprising a coating covering a front surface and the outer surface of the body and bonding the scrapers to the outer surface of the body.

3. The pig of claim 2, further comprising second coating covering a rear surface of the body and a rear surface of the scrapers.

4. The pig of claim 1, further comprising a plate bonded to a longitudinal end of the body.

5. The pig of claim 1, wherein a front longitudinal end of the body forms a nose.

6. The pig of claim 5, wherein the scrapers extend from a rear longitudinal end of the body to at least a portion of the nose.

7. The pig of claim 1, wherein the scrapers are brushes.

8. The pig of claim 1, wherein scrapers substantially occupy an outer surface of the body.

9. The pig of claim 8, wherein scrapers occupy at least two-thirds of the outer surface of the body.

10. The pig of claim 1, wherein the scrapers are longitudinally straight.

11. The pig of claim 1, wherein the scrapers are helical.

12. The pig of claim 1, wherein the body is made from a polymer.

13. The pig of claim 12, wherein polymer is foamed.

14. A pig for cleaning a tubular string, comprising:
a cylindrical body;
a scraper wound around and along an outer surface of the body, the scraper operable to engage and clean an inner surface of the tubular string; and
a bypass formed between windings of the scraper, the bypass operable to:
intake a portion of propellant from a tail of the body,
conduct the portion of propellant along and around an outer surface of the body, and
discharge the portion of propellant in front of the body.

15. A method of cleaning a tubular string, comprising:
injecting propellant behind a pig, thereby propelling the pig through the tubular string; and
bypassing a portion of the propellant along an outer portion to a front of the pig, thereby creating a jet in front of the pig.

16. The method of claim 15, wherein the tubular string is coiled tubing or reeled pipe.

17. The method of claim 15, wherein the pig comprises:
a cylindrical body;
two or more scrapers disposed along an outer surface of the body, the scrapers operable to engage and clean an inner surface of the tubular string; and
a bypass formed between the scrapers.

18. The method of claim 15, wherein the pig comprises:
a cylindrical body;
a scraper wound around and along an outer surface of the body, the scraper operable to engage and clean an inner surface of the tubular string; and
a bypass formed between windings of the scraper.

19. The method of claim 15, wherein an outer diameter of the pig is slightly larger than an inner diameter of the tubular string.

20. The method of claim 15, wherein the pig comprises:
a mandrel;
a seal coupled to the mandrel, operable to engage an inner surface of the tubular string, and having a bypass formed longitudinally therethrough; and
a scraper disposed along the mandrel, the scraper operable to engage and clean an inner surface of the tubular string.

21. The method of claim 15, wherein the pig is cycled through the tubular string until a white-metal or near white-metal finish is achieved.

22. The regimen of claim 15, further comprising:
coating an inner surface of the tubular string with a polymer coating; and
injecting dry air through the tubular string or heating the tubular string, thereby drying or curing the coating.

23. A pig for cleaning a tubular string, comprising:
a mandrel;
a seal coupled to the mandrel, operable to engage an inner surface of the tubular string, and having a bypass formed longitudinally therethrough; and
a scraper disposed along the mandrel, the scraper operable to engage and clean an inner surface of the tubular string.

24. The pig of claim 23,
further comprising a second seal operable to engage an inner surface of the tubular string and having a bypass formed longitudinally therethrough,
wherein each seal is disposed at each end of the mandrel and the scraper is disposed between the seals.

25. The pig of claim 23, wherein the seal is a disc made from a polymer.

26. The pig of claim 23, wherein the scraper is a brush helically extending along the mandrel.

27. The pig of claim 23, wherein:
an outer surface of the mandrel is threaded,
an inner surface of the scraper is threaded, and
an inner surface of the seal is threaded.

28. The pig of claim 23, wherein the bypass is formed in an outer surface of the seal.
